(19) United States
(12) Patent Application Publication
(10) Pub. No.: US 2012/0018275 A1
(43) Pub. Date: Jan. 26, 2012

(54) Rear Driveline Disconnect Apparatus

(76) Inventors: Edward J. Voth, Clovis, CA (US); Matthew J. Messer, Fresno, CA (US); Allen E. Alexander, Fresno, CA (US); Aaron T. Young, Fresno, CA (US)

(21) Appl. No.: 13/166,744

(22) Filed: Jun. 22, 2011

Related U.S. Application Data
(60) Provisional application No. 61/357,355, filed on Jun. 22, 2010.

(51) Int. Cl. F16D 25/06; F16D 25/00

(52) U.S. Cl. 192/85.01; 192/30 R

(57) ABSTRACT

A rear driveline disconnect apparatus for use with four-wheel drive vehicles that is configured to allow the driver to easily, quickly and reliably change the vehicle between a four-wheel drive mode of operation and a front two-wheel drive mode of operation. The apparatus comprises a housing having an adapter at one end that mounts to the vehicle transfer case and an output flange at the opposite end that connects to the rear driveline assembly. The shaft from the transfer case is received in the housing and engaged by an output gear disposed therein. A coupling mechanism selectively couples and uncouples the output gear with an output shaft that extends rearward to connect to the output flange and the vehicle's rear drive shaft. When coupled, rotational torque is delivered to the rear driveline assembly to power the rear wheels. When uncoupled, only the front driveline assembly and front wheels receives power.

### CROSS-REFERENCE TO RELATED APPLICATIONS

This patent application claims priority to U.S. Provisional Patent Application No. 61/357,355 filed Jun. 22, 2011.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The present invention relates generally to apparatuses for use with four-wheel drive vehicles and the like that are selectively utilized to improve the handling and operation of the vehicle during certain road or driving conditions. In particular, the present invention relates to such apparatuses that connect to the vehicle driveline in a manner that allows the operator to shift into a front wheel operation by disconnecting the rear driveline system. Even more particularly, the present invention relates to such apparatuses and systems utilizing the apparatus that provide quick and reliable disconnecting of the rear driveline system.

B. Background

Many vehicles are equipped with a four-wheel driveline system that allows the engine to turn all four wheels, as opposed to just the rear or front wheels, at the same time for improved traction and other operation during certain driving conditions, particularly when driving “off-road” or in ice, snow, mud, sand and gravel conditions. These vehicles are commonly referred to as four-wheel drive or 4×4 vehicles. As with all motor vehicles, a four-wheel drive vehicle has a powertrain and a driveline that is configured to power the vehicle in a manner that beneficially allows the user thereof to drive the vehicle over all types of terrain, including highways, roads, streets and off-road areas. In a four-wheel vehicle, the powertrain generally comprises the engine and the transmission and the driveline generally comprises a transfer case, a pair of drive shafts, front and rear differentials and the front and rear wheel systems, each of which has a pair of wheels. These components are operatively connected in a manner such that all four wheels can be powered to provide additional traction to move the vehicle over terrain that would otherwise be difficult for a two-wheeled vehicle. As commonly known, the engine delivers power to the transmission, the transfer case delivers torque to drive shafts that connect to the front and rear differentials and the front/rear differentials drive, respectively, the vehicle's front and rear wheels. In general, the differentials are devices that are capable of delivering torque to drive a pair of wheels while allowing the wheels to rotate at different speeds when necessary for beneficial operation of the vehicle, such as when the vehicle is turning a corner. Although some four-wheel drive vehicles are equipped such that the vehicle is always in four-wheel drive operation, most four-wheel drive vehicles allow the user to manually select whether the vehicle is in four-wheel or two-wheel drive operation. Some four-wheel drive vehicles have a system which automatically switches between four-wheel and two-wheel drive operation depending on the terrain and driving conditions.

Although four-wheel drive vehicle operation was initially just utilized to provide improved traction in hard driving conditions, such as in ice, snow, mud, gravel, sand and the like, many people now utilize their four-wheel drive vehicles for recreation purposes, where the recreation is driving the four-wheel drive vehicle over rough or very rough terrain. The recreation activities include off-road racing and other competitions, off-road exploration or adventure, “rock crawling” and the like. As known by those who participate in such activities, the four-wheel drive sport has evolved significantly since its inception in the 1960's. Generally, the terrain is much rougher, the tire sizes are bigger and the drivers are pushing their vehicles much harder. One type of four-wheel drive competition requires the driver to navigate a series of obstacles in a set amount of time. This type of four-wheel drive activity, as well as others, requires a capable, yet maneuverable, vehicle.

Most four-wheel drive vehicles have differential lockers in each axle to provide maximum traction at each wheel, which allows power to be transferred to all four wheels in forward or reverse. As well known, a disadvantage of the use of large tires and locked differentials is that the four-wheel drive vehicle becomes much more difficult to turn, making it hard to safely and effectively make corners. While most four-wheel drive vehicles can typically shift into rear two-wheel drive operation, it would generally be more beneficial if the four-wheel drive vehicle could shift into front two-wheel drive operation when the vehicle is making a turn or moving around a corner. While there are transfer cases available on the market that function to place a four-wheel drive vehicle in front two-wheel drive operation and rear driveline disconnect mechanisms that result in the vehicle being in front two-wheel drive operation, presently available apparatuses and systems do not allow the desired disconnecting operation to happen with ease and reliability. For instance, certain systems require use of a somewhat cumbersome lever-actuated device in a relatively awkward position under the vehicle to engage or disengage the rear portion of the driveline assembly. Yet other systems required the use of a cable-connected control linkage assembly to engage or disengage the rear portion of the driveline assembly. These systems are also often utilized for towing vehicles, including rear two-wheel drive vehicles. In addition to the above limitations, presently available apparatuses and systems are generally quite expensive to purchase and install.

What is needed, therefore, is an improved apparatus for use with four-wheel drive vehicles that is configured to quickly, easily and reliably change the vehicle from four-wheel drive operation to front two-wheel drive operation to allow the driver of the vehicle to more easily and safely steer the vehicle while he or she is turning and while performing certain maneuvers in off-road situations. Such an apparatus should be adaptable to installation in the driveline of a four-wheel drive vehicle and configured to allow the driver to selectively disengage the rear portion of the driveline assembly from the transfer case to achieve the front two-wheel drive operation. Preferably, the apparatus for engaging or disengaging the rear portion of the driveline assembly should be configured to attach to the vehicle's existing transfer case and operatively connect the existing transfer case output shaft to the vehicle's existing rear drive shaft. The preferred apparatus should allow the driver to selectively change between four-wheel drive mode and front two-wheel drive mode from within the vehicle by using an easily accessible switching mechanism.

### SUMMARY OF THE INVENTION

The rear driveline disconnect apparatus of the present invention provides the benefits and solves the problems identified above. That is to say, the present invention discloses an apparatus which is utilized with a four-wheel drive vehicle to quickly, easily and reliably change the vehicle from its four-wheel drive operation to a front two-wheel drive operation in order to allow the driver of the vehicle to more easily and safely steer the vehicle while he or she is turning and/or while performing certain maneuvers in various off-road situations. The rear driveline disconnect apparatus is adaptable for installation in the driveline of a four-wheel drive vehicle and configured to allow the driver to selectively engage and disengage the rear portion of the driveline assembly from the transfer case to change the vehicle between four-wheel drive and front two-wheel drive operation. The apparatus of the present invention is configured to be attached to a vehicle's existing transfer case and to operatively connect the existing transfer case output shaft to the vehicle's existing rear drive shaft. In a preferred configuration of the present invention, the rear driveline disconnect apparatus allows the driver of a four-wheel drive vehicle to selectively change between a four-wheel drive mode of operation and a front two-wheel drive mode of operation by using an easily accessible switching mechanism located within the interior compartment of the vehicle. In one embodiment, the rear driveline disconnect apparatus operatively connects to a source of pressurized air, which is often used with four-wheel drive vehicles for air-powered locking differentials, tire inflation/deflation and other uses, associated with the four-wheel drive vehicle to provide a pneumatically operated system. Alternatively, the apparatus of the present invention can be hydraulically or electrically operated.

In a preferred embodiment of the present invention, the rear driveline disconnect apparatus generally comprises a housing enclosing many of the components of the apparatus, an adapter at the first end of the apparatus, an output flange at the second end of the apparatus, an output gear in the housing that is configured to engage the vehicle's transfer case output shaft, a driveline output shaft that extends rearwardly to the output flange and which operatively connects to the vehicle's rear drive shaft and a coupling mechanism disposed in the housing in coupling relation with the output gear for selectively coupling and uncoupling the driveline output shaft with the transfer case output shaft. The adapter at the first end of the apparatus is sized and configured to attach the housing to the transfer case of the vehicle. The output flange at the second end of the apparatus is sized and configured to attach to the rear driveline assembly. One or more first bearings in the housing rotatably support the transfer case output shaft when the shaft is received inside the housing. One or more second bearings in the housing at or near the second end of the housing are configured to rotatably support the driveline output shaft. The apparatus transfers rotational power to the rear driveline assembly when the coupling mechanism is coupled and does not transfer rotational power to the rear driveline assembly when the coupling mechanism is uncoupled. A switch is operatively connected to the apparatus for selectively engaging or disengaging the coupling mechanism. In the preferred embodiment, a pneumatic fitting is located on the housing to connect the apparatus to an air compressor associated with the vehicle, with the coupling mechanism being configured to be operated by pressurized air from the air compressor. In a preferred embodiment,the coupling mechanism comprises a shift collar coupler configured to be in selective engagement with the output gear, a shift fork connected to the shift collar coupler to move the shift collar coupler and a piston connected to the shift fork, with the piston being configured to move in a chamber to move the shift fork and the shift collar coupler to operatively disengage the shift collar coupler from the output gear and uncouple the driveline output shaft from the transfer case output shaft. The coupling mechanism also has one or more springs in biasing arrangement with the shift fork so as to bias the shift fork and move the shift collar coupler in order to operatively engage the shift collar coupler with the output gear and couple the driveline output shaft with the transfer case output shaft. In the preferred embodiment, the switch is located in the driver's compartment of the vehicle.

Accordingly, the primary aspect of the present invention is to provide an improved rear driveline disconnect apparatus for four-wheel drive vehicles that has the advantages discussed above and which overcomes the disadvantages and limitations associated with presently utilized apparatuses to disconnect the rear driveline assembly.

It is an important aspect of the present invention to provide a rear driveline disconnect apparatus that allows the driver of a four-wheel drive vehicle to quickly, easily and reliably change the operation of the vehicle from four-wheel drive to front two-wheel drive so he or she may more easily and safely steer the vehicle when making turns and performing certain off-road maneuvers.

It is also an important aspect of the present invention to provide a rear driveline disconnect apparatus that mounts to the existing vehicle transfer case and which operatively connects to the existing transfer case output shaft and the existing drive shafts in a manner which allows the driver of the vehicle to change between a four-wheel drive mode of operation and a front two-wheel drive mode of operation.

It is also an important aspect of the present invention to provide a rear driveline disconnect apparatus that is relatively less expensive to purchase and somewhat easier to install in a four-wheel drive vehicle.

It is also an important aspect of the present invention to provide an improved rear driveline disconnect apparatus for four-wheeled drive vehicles that is configured to allow quick, easy and reliable change between four-wheel drive operation and two-wheel drive operation by the driver while he or she is inside the driver's compartment of the vehicle.

Another important aspect of the present invention is to provide a rear driveline disconnect apparatus that utilizes compressed air, preferably from a vehicle's existing pneumatic air supply system, to allow the driver of a four-wheel drive vehicle to operate a conveniently located switch to change between four-wheel drive operation and front two-wheel drive operation.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of an exemplary four-wheel drive vehicle having a rear driveline disconnect apparatus configured according to one embodiment of the present invention;

FIG. 2 is a bottom view of the vehicle of FIG. 1 showing the location of the rear driveline disconnect configured according to one embodiment of the present invention;

FIG. 3 is a rear perspective view of the rear driveline disconnect apparatus of FIGS. 1 and 2 shown connected to the vehicle's existing rear driveline drive flange and transfer case output shaft;

FIG. 4 is a side view of the rear driveline disconnect apparatus of FIG. 3;

FIG. 5 is a cross-sectional side view of the driveline disconnect apparatus of FIG. 4 taken through lines 5-5 in FIG. 3;

FIG. 6 is a rear perspective view of the intermediate housing of the driveline disconnect apparatus of FIG. 3;

FIG. 7 is a side view of the intermediate housing of FIG. 6;

FIG. 8 is a rear view of the intermediate housing of FIG. 6;

FIG. 9 is a front view of the intermediate housing of FIG. 6; and

FIG. 10 is a schematic view of a system utilizing the rear driveline disconnect apparatus of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show and discuss certain shapes and configurations for the components of a preferred embodiment of the rear driveline disconnect apparatus of the present invention, those skilled in the art will readily appreciate that this is merely for purposes of simplifying this disclosure and that the present invention is not so limited.

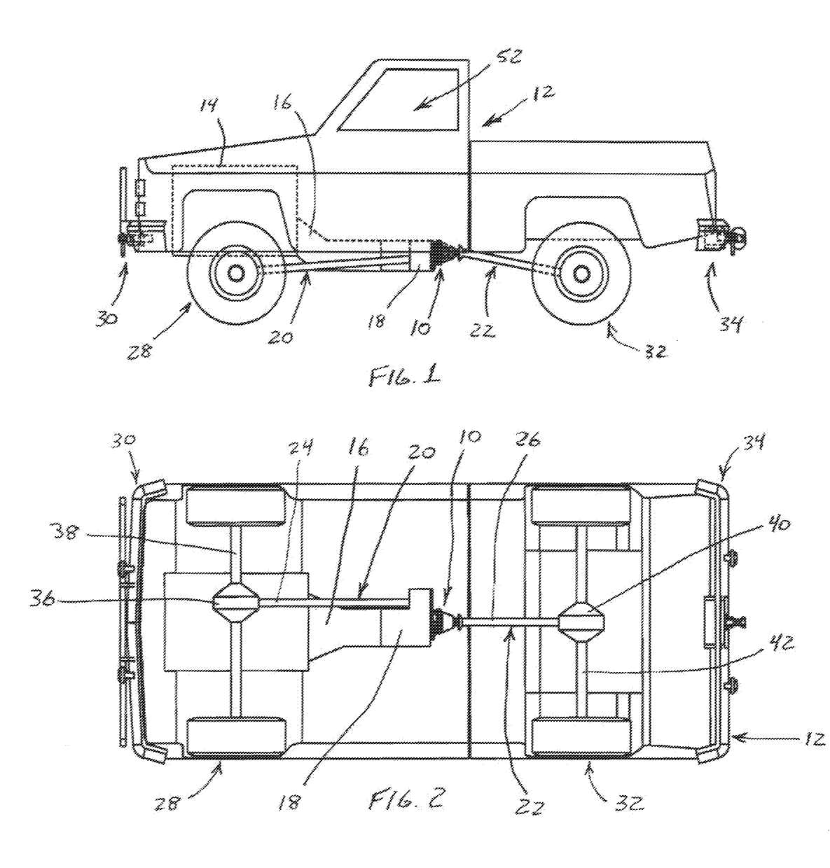

A rear driveline disconnect apparatus that is configured pursuant to one embodiment of the present invention is shown generally as 10 in FIGS. 1 through 5. As will be explained in more detail below, the rear driveline disconnect apparatus 10 is utilized with a four-wheel drive vehicle, an example of which is shown as 12 in FIGS. 1 and 2, to allow the driver of vehicle 12 to easily, quickly and reliably change between four-wheel drive operation and front two-wheel drive operation to more easily steer the vehicle 12 when he or she is making a turn or performing certain off-road maneuvers with vehicle 12. As well known in the art, vehicle 12 has an engine 14 which connects to transmission 16 to provide torque to transfer case 18 that is then transmitted to the front driveline assembly 20 and rear driveline assembly 22 via a front drive shaft 24 and rear drive shaft 26 to power the front wheels 28 towards the front end 30 of the vehicle 12 and the rear wheels 32 towards the back end 34 of the vehicle 12, as shown in FIGS. 1 and 2. Front wheels 28 rotate as a result of rotational power provided by the front drive shaft 24 via front differential 36 and front axles 38 and rear wheels 32 rotate as a result of rotational power provided by the rear drive shaft 26 via rear differential 40 and rear axles 42. In four-wheel drive operation, the rotational torque from transfer case 18 is transmitted to each of the front wheels 28 and rear wheels 32 via, respectively, the front driveline assembly 20 and the rear driveline assembly 22. In front two-wheel drive operation, the rotational torque from the transfer case 18 is transmitted to the front wheels 28, through the front driveline assembly 20, but not to the rear wheels 32. As will be explained in more detail below, in the front two-wheel drive mode of operation the rear driveline disconnect apparatus 10 of the present invention is utilized with vehicle 12 to effectively disconnect the rear drive shaft 26 from the torque at transfer case 18 so torque is not transferred through the rear driveline assembly 22 to rear wheels 32. As known, in the front two-wheel drive mode of operation, the engine 14 will drive the front wheels 28 but the rear wheels 32 will rotate without being driven by engine 14.

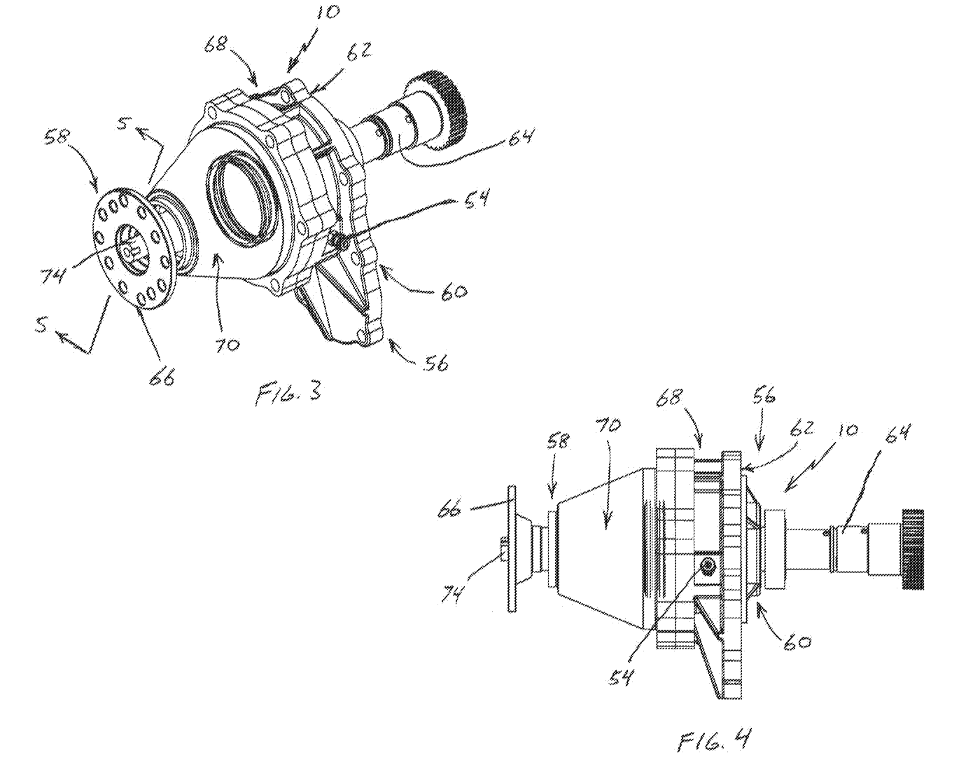

Many four-wheel drive vehicles 12 have an on-board air compressor system, including an air compressor, to actuate an air-powered locking differential utilized with the vehicle 12. In the preferred embodiment of the present invention, the apparatus 10 pneumatically connects to this air compressor, shown as 44 in FIG. 10, and utilizes the pressurized air, via air line 46, to operate the apparatus 10 so as to change the operation of the vehicle 12 between its four-wheel drive and front two-wheel drive modes of operation. In the preferred embodiment, a switch 48, which is operatively connected to the air compressor 44 via switch line 50 (which may comprise a pneumatic or electrical connection), that is preferably located in the driver's compartment 52 of vehicle 12, as shown in FIGS. 1 and 10. In one embodiment, the switch 48 is located on the dashboard in easy reach of the driver when he or she is driving vehicle 12. The air line 46 from compressor 44 connects to apparatus 10 at a pneumatic fitting 54 associated with apparatus 10, as shown in FIGS. 3 and 4. The pressurized air, as well as the appropriate electropneumatic controls, allows the driver to change between the four-wheel drive and front two-wheel drive modes of operation by merely flipping switch 48. With the rear driveline assembly 22 disengaged, the driver can more easily and safely steer the vehicle to make a turn and/or perform other maneuvers in various off-road situations. With the rear driveline assembly 22 engaged, the driver can achieve improved traction in ice, snow, mud, sand, gravel and like conditions and/or more easily accomplish various off-road tasks, such as rock crawling or the like.

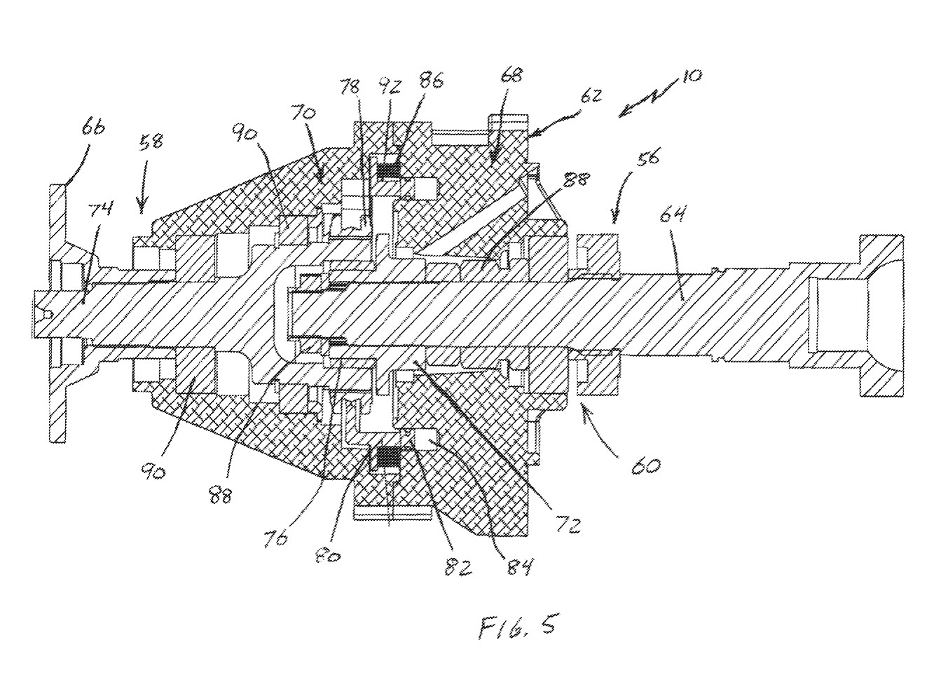

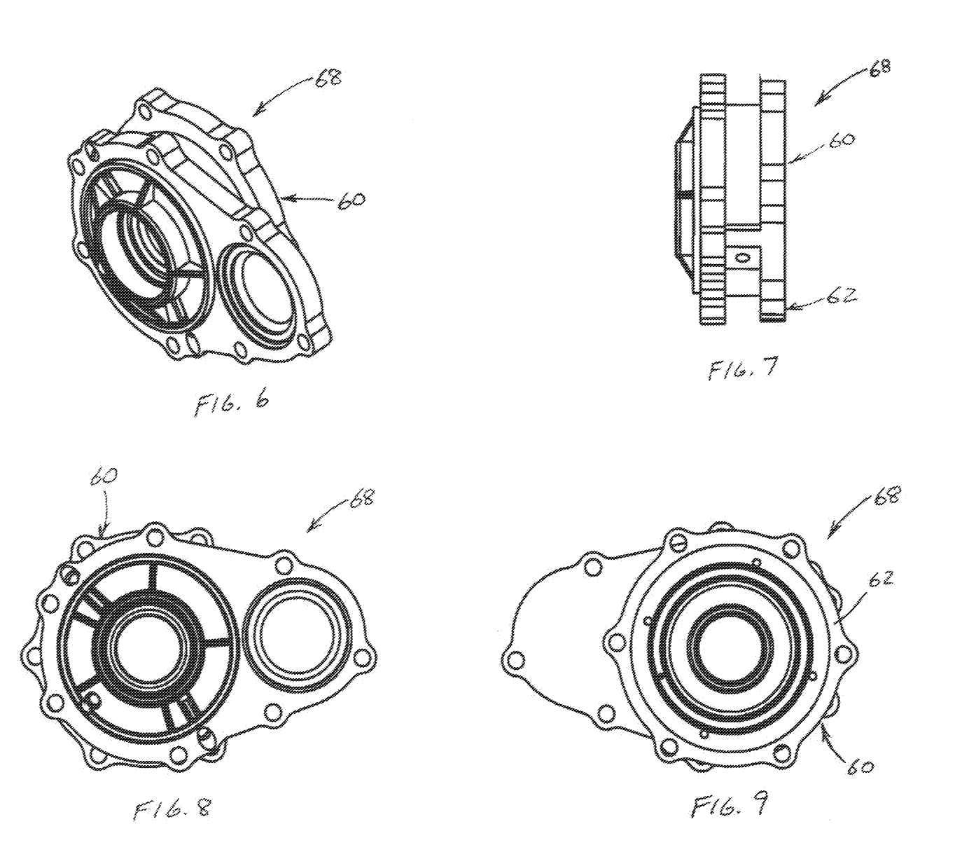

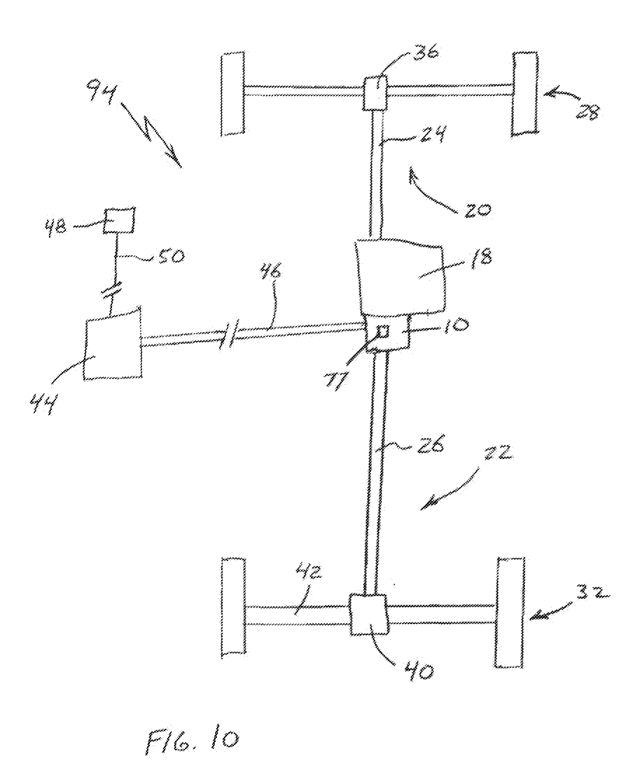

As explained in more detail below, the apparatus 10 of the present invention is fixedly positioned between the vehicle's existing transfer case 18 and its rear driveline assembly 22. The placement of the apparatus 10 in this position will require the existing rear drive shaft 26 to be shortened or for it to be replaced by a new, shorter rear drive shaft 26. The apparatus 10 has a first end 56 that is positioned adjacent to transfer case 18 and a second end 58 that is positioned adjacent the forward end of the rear drive shaft 26 of rear driveline 22, as best shown in FIGS. 2 through 5. The apparatus 10 has a transfer case adapter 60, with a forwardly facing adapter face 62, that is sized and configured to bolt directly to the existing transfer case 18 and to rotatably engage the existing transfer case output shaft 64, as best shown in FIG. 5. The second end 58 of apparatus 10 has a output flange 66, as shown in FIGS. 3 through 5, that fixedly connects to the rear driveline 22. In the preferred embodiment of the present invention, output flange 66 is the same flange which is taken off of the existing transfer case 18 when preparing vehicle 12 for installation of the apparatus 10 of the present invention. A housing encloses the internal components of apparatus 10, including bearings, gears, seals and like components, to protect them from water, mud, dirt, sand and other contaminants and to reduce the likelihood that contact will significantly damage apparatus 10. In the embodiment shown in the figures, apparatus 10 has a two-piece housing, comprising a first or intermediate housing 68 and a second or tail housing 70, as shown in FIGS. 3 through 5. In general, first housing 68 encloses the forward or transfer case side components of apparatus 10 and second housing 70 encloses the rearward or driveline side components of apparatus 10. As best shown in FIG. 5, the transfer case adapter 60 and adapter face 62 are supported by and defined by the first housing 68. In the second housing 70, near its interface with the first housing 68, an output gear 72 operatively engages the rearward end of the existing transfer case output shaft 64. A new driveline output shaft 74, which is supportedly engaged by output flange 66 extends rearwardly from the transfer case output shaft 64, as also shown in FIG. 5. The output gear 72 connects the existing transfer case output shaft 64 to the driveline output shaft 74, with pilot bearing 76 operatively disposed therebetween. Output gear 72 ensures that the existing transfer case output shaft 64 will have the same gear teeth as the driveline output shaft 74.

The apparatus has a coupling mechanism 77, best shown in FIGS. 5 and 10, that selectively connects and disconnects (couples/uncouples) the shafts 64/74 to engage or disengage, respectively, the rear driveline assembly 22 of the vehicle 12 to transfer torque to or not transfer torque to the rear wheels 32. In the preferred embodiment, coupling mechanism 77 comprises a shift collar coupler 78 at the connection of the rearward end of the transfer case output shaft 64 and the forward end of the driveline output shaft 74 to selectively couple and uncouple the two shafts 64/74. A shift fork 80 is utilized to disengage shift collar coupler 78. A piston 82, having o-rings and being slidably disposed in chamber 84, is connected to shift fork 80 and configured to linearly move shift fork 80 so as to disengage the shift collar coupler 78, as shown in FIG. 5, so as to disengage the rear driveline assembly 22. Springs 86, shown in their biased position in FIG. 5, are utilized to bias the shift fork 80 and move the shift collar coupler 78 back into its engaged position so as to engage the rear driveline assembly 22 and rotatably drive rear wheels 32. Upon application of pressurized air, the piston 82 moves the shift fork 80 to disengage the rear driveline assembly 22. When the air pressure is released, the springs 86 bias the shift fork 80 rearward to move the coupler 78 to its engaged position. A plurality of first bearings 88 rotatably support the transfer case output shaft 64 and a plurality of second bearings 90 rotatably support driveline output shaft 74, as shown in FIG. 5. Shift fork guide pins 92 guide the linear movement of shift fork 80 as it engages and disengages the shift collar coupler 78.

FIG. 10 shows a preferred system 94 utilizing the above-described rear driveline disconnect apparatus 10. In the embodiment shown in FIG. 10, the system 94 primarily comprises the apparatus 10, having the coupling mechanism 77, vehicle 12, the vehicle transfer case 18, the vehicle's front driveline assembly 20 and rear driveline assembly 22, an air compressor 44 that is pneumatically connected to the apparatus 10 and a switch 48 operatively connected to the air compressor 44 so as to deliver pressurized air to the apparatus 10 to operate the coupling mechanism 77.

The cooperative operation of the above components is hereinafter explained. During “normal” four-wheel drive operation, with the front driveline assembly 20 supplying rotational torque to the front wheels 24 and the rear driveline assembly 22 supplying rotational torque to rear wheels 26, both of the front wheels 24 and rear wheels 26 will be powered by engine 14. The transfer case output shaft 64 is connected, via the shift collar coupler 78, to the driveline output shaft 74. When the apparatus 10 is activated, in a preferred embodiment by the operation of switch 48 to release compressed air from air compressor 44, the pressurized air pushes the pistons 82 against the shift fork 80, which moves the shift collar coupler 78 off of the driveline output shaft 74. The movement of the coupler 78 disconnects the driveline output shaft 74 from the transfer case output shaft 64, causing the rear drive shaft 26 of the rear driveline assembly 22 to cease being rotated by the torque produced by engine 14. At this time, only the front wheels 28 will be powered by engine 14, placing the vehicle 12 in its front two-wheel drive condition. When the air pressure is released, by operating the switch 48 to deactivate the pressurized air from air compressor 44, springs 86 push against the shift fork 80, which moves the shift collar coupler 78 to couple the transfer case output shaft 64 with the driveline output shaft 74. This causes the rear driveline assembly 22 to be rotatably coupled with the transfer case output shaft 64, thereby supplying torque from engine 14 to drive the rear wheels 32 and place the vehicle 12 in its four-wheel drive condition.

In use, the owner or operator of vehicle 12 installs or has installed the rear driveline disconnect apparatus 10 of the present invention at the rear of the vehicle's existing transfer case 18 between the transfer case 18 and the rear driveline assembly 22. Preferably, the output flange 66 is removed from transfer case 18 and utilized at the second end 58 of the apparatus 10. The air line 46 from the source of compressed air, such as air compressor 44, is connected to the pneumatic fitting 54 located on the apparatus 10. Typically, the existing rear drive shaft 26 of the rear driveline assembly 22 would have to be shortened to account for the added length of the apparatus 109. The adapter face 62 of the transfer case adapter 60 is bolted to the transfer case 18 and the output flange 66 is connected to the rear driveline assembly 22, with the rearward end of the driveline output shaft 74 being coupled or otherwise connected to the rear drive shaft 26. The switch 48 is mounted in the dash of the driver's compartment 52 of vehicle 12, or elsewhere in vehicle 12 that is conveniently accessed by the driver while driving the vehicle 12, and connected, typically either pneumatically or electrically via switch line 50, to the air compressor 44 to supply pressurized air to the apparatus 10. Once installed, the driver of the vehicle 12 can easily, quickly and reliably change between four-wheel drive operation and front, two-wheel drive operation by merely operating the switch 48. Activating the switch 48 will deliver pressurized air to the apparatus 10, causing the apparatus 10 to uncouple the connection between the transfer case 18 and the rear driveline assembly 22, thereby severing the link that normally delivers rotational torque to the rear drive shaft 26 to drive the rear wheels 32. This condition will leave the vehicle 12 in its front two-wheel drive mode of operation. Deactivating the switch 48 will prevent pressurized air from being delivered to the apparatus 10, thereby allowing the apparatus 10 to re-couple the rotational connection between the transfer case 18 and the rear driveline assembly 22 and deliver rotational torque to the rear drive shaft 26 to power the rear wheels 32. This condition will return the vehicle 12 to its normal four-wheel drive mode of operation. This change between the different modes of operation for vehicle 12 can continue as long as there is supply of pressurized air to the apparatus 10.

As will be readily appreciated by persons skilled in the art, the exact configuration and arrangement of the housing adapters and gear sets will depend on the make and model of vehicle 12. The example embodiment shown in the figures is configured for use with Toyota® transfer cases. The apparatus 10 can be easily adapted to fit transfer cases utilized with other vehicles having different transfer case and/or gear configurations. Although a variety of different materials can be utilized for apparatus 10, materials that are typical for existing transfer cases, gears, bearings and other relevant components are also likely to be suitable for use with apparatus 10. Likewise, materials and equipment used in pneumatic systems can be utilized with apparatus 10 to deliver pressurized air from air compressor 44. In one embodiment, apparatus 10 can be provided as a relatively easy to install kit that is utilized with the vehicle's existing pressurized air system. A number of alternative components can be utilized with apparatus 10. For instance, instead of utilizing pneumatic activation, apparatus 10 can be adapted to be electrically or hydraulically activated. Switch 48 can be utilized to send an electrical signal to an electrically driven device that moves the shift collar coupler 78 or send a pressurized hydraulic fluid to a hydraulically driven device that moves the shift collar coupler 78.

While there are shown and described herein one or more specific embodiments of the invention, it will be readily apparent to those skilled in the art that the invention is not so limited, but is susceptible to various modifications and rearrangements in design and materials without departing from the spirit and scope of the invention. In particular, it should be noted that the present invention is subject to various modifications with regard to any dimensional relationships set forth herein, with regard to its assembly, size, shape and use and with regard to the materials used in its construction. For instance, there are a number of components described herein that can be replaced with equivalent functioning components to accomplish the objectives of the present invention.

What is claimed is:

1. A rear driveline disconnect apparatus for a four-wheel drive vehicle having a transfer case operatively connected to a front driveline assembly and a rear driveline assembly so as to deliver rotational torque to each of said front driveline assembly and said rear driveline assembly, said apparatus comprising:
a housing;
an adapter at a first end of said apparatus that is sized and configured to attach said housing to said transfer case of said vehicle;
an output flange at a second end of said apparatus that is sized and configured to attach to said rear driveline assembly, said rear driveline assembly having a rear drive shaft;
one or more first bearings in said housing configured to rotatably support a transfer case output shaft associated with said transfer case when said transfer case output shaft is received inside said housing;
an output gear in said housing configured to be operatively engaged with said transfer case output shaft when said transfer case output shaft is received in said housing;
a driveline output shaft extending from said output gear in said housing to said output flange, said driveline output shaft configured to be operatively connected to said rear drive shaft;
one or more second bearings in said housing at or near said second end of said housing, each of said one or more second bearings configured to rotatably support said driveline output shaft;
a coupling means disposed in said housing in coupling relation with said output gear for selectively coupling and uncoupling said driveline output shaft with said transfer case output shaft, said coupling means configured to transfer rotational power to said rear driveline assembly when said coupling means is coupled and to not transfer rotational power to said rear driveline assembly when said coupling means is uncoupled; and
a switch operatively connected to said apparatus for selectively engaging or disengaging said coupling means.

2. The apparatus of claim 1 further comprising a pneumatic fitting on said housing, said pneumatic fitting adapted to connect to an air compressor associated with said vehicle, said coupling means configured to be powered by pressurized air from said air compressor.

3. The apparatus of claim 1, wherein said coupling means comprises a shift collar coupler configured to be in selective engagement with said output gear, a shift fork connected to said shift collar coupler so as to move said shift collar coupler and a piston connected to said shift fork, said piston configured to move in a chamber so as to move said shift fork and said shift collar coupler so as to operatively disengage said shift collar coupler from said output gear to uncouple said driveline output shaft with said transfer case output shaft.

4. The apparatus of claim 3, wherein said coupling means further comprises one or more springs in biasing arrangement with said shift fork so as to bias said shift fork and move said shift collar coupler so as to operatively engage said shift collar coupler with said output gear to couple said driveline output shaft with said transfer case output shaft.

5. The apparatus of claim 1, wherein said housing comprises a first housing having said adapter and being disposed toward said transfer case and a second housing being disposed toward said rear driveline assembly and joined with said first housing.

6. The apparatus of claim 1, wherein said adapter has an adapter face configured for engagement with said transfer housing.

7. The apparatus of claim 1, wherein said switch is located in a driver's compartment of said vehicle.

8. A rear driveline disconnect apparatus for a four-wheel drive vehicle having a transfer case operatively connected to a front driveline assembly and a rear driveline assembly so as to deliver rotational torque to each of said front driveline assembly and said rear driveline assembly, said apparatus comprising:
a housing;
an adapter at a first end of said apparatus that is sized and configured to attach said housing to said transfer case of said vehicle;
an output flange at a second end of said apparatus that is sized and configured to attach to said rear driveline assembly, said rear driveline assembly having a rear drive shaft;
one or more first bearings in said housing configured to rotatably support a transfer case output shaft associated with said transfer case when said transfer case output shaft is received inside said housing;
an output gear in said housing configured to be operatively engaged with said transfer case output shaft when said transfer case output shaft is received in said housing;
a driveline output shaft extending from said output gear in said housing to said output flange, said driveline output shaft configured to be operatively connected to said rear drive shaft;
one or more second bearings in said housing at or near said second end of said housing, each of said one or more second bearings configured to rotatably support said driveline output shaft;
a shift collar coupler configured to be in selective engagement with said output gear;
a shift fork connected to said shift collar coupler so as to move said shift collar coupler;
a piston connected to said shift fork, said piston configured to move in a chamber so as to move said shift fork and said shift collar coupler so as to operatively disengage said shift collar coupler from said output gear to uncouple said driveline output shaft with said transfer case output shaft so as to transfer rotational torque from said transfer case only to said front driveline assembly; and
one or more springs in biasing arrangement with said shift fork so as to bias said shift fork and move said shift collar coupler so as to operatively engage said shift collar coupler with said output gear to couple said driveline output shaft with said transfer case output shaft so as to transfer rotational torque from said transfer case to said rear driveline assembly.

9. The apparatus of claim 8 further comprising a switch operatively connected to said apparatus for selectively coupling and uncoupling said rear driveline assembly with said transfer case output shaft.

10. The apparatus of claim 9, wherein said switch is operatively connected to an air compressor associated with said vehicle to selectively deliver pressurized air to said apparatus so as to move said piston and operatively disengage said shift collar coupler from said output gear.

11. The apparatus of claim 10 further comprising a pneumatic fitting on said housing, said pneumatic fitting adapted to connect to said air compressor.

12. The apparatus of claim 9, wherein said switch is located in a driver's compartment of said vehicle.

13. The apparatus of claim 8, wherein said housing comprises a first housing having said adapter and being disposed toward said transfer case and a second housing being disposed toward said rear driveline assembly and joined with said first housing.

14. The apparatus of claim 8, wherein said adapter has an adapter face configured for engagement with said transfer housing.

15. A rear driveline disconnect system for use with a four-wheel drive vehicle having a transfer case operatively connected to a front driveline assembly and a rear driveline assembly so as to deliver rotational torque to each of said front driveline assembly and said rear driveline assembly, said system comprising:
a rear driveline disconnect apparatus interconnecting said transfer case and said rear driveline assembly, said rear driveline disconnect apparatus having an output gear operatively engaged with a transfer case output shaft of said transfer case and a driveline output shaft extending from said output gear to an output flange engaged with said rear driveline assembly, said driveline output shaft configured to be operatively connected to a rear drive shaft of said rear driveline assembly;
a coupling means associated with said rear driveline disconnect apparatus, said coupling means in coupling relation with said output gear for selectively coupling and uncoupling said driveline output shaft with said transfer case output shaft, said coupling means configured to transfer rotational power to said rear driveline assembly when said coupling means is coupled and to not transfer rotational power to said rear driveline assembly when said coupling means is uncoupled; and
a switch operatively connected to said coupling means so as to operate said coupling means to selectively couple and uncouple said driveline output shaft with said transfer case output shaft.

16. The system of claim 15, wherein said rear driveline disconnect apparatus has a housing and said coupling means is disposed in said housing.

17. The system of claim 15, wherein said coupling means comprises a shift collar coupler configured to be in selective engagement with said output gear, a shift fork connected to said shift collar coupler so as to move said shift collar coupler and a piston connected to said shift fork, said piston configured to move in a chamber so as to move said shift fork and said shift collar coupler so as to operatively disengage said shift collar coupler from said output gear to uncouple said driveline output shaft with said transfer case output shaft.

18. The system of claim 17, wherein said coupling means further comprises one or more springs in biasing arrangement with said shift fork so as to bias said shift fork and move said shift collar coupler so as to operatively engage said shift collar coupler with said output gear to couple said driveline output shaft with said transfer case output shaft.

19. The system of claim 18 further comprising an air compressor associated with said vehicle, said switch operatively connected to said air compressor so as to selectively deliver pressurized air to said apparatus to move said piston and operatively disengage said shift collar coupler from said output gear and operatively disengage said rear driveline assembly from said transfer case output shaft so as to transfer rotational torque from said transfer case only to said front driveline assembly.

20. The system of claim 15 further comprising an air compressor associated with said vehicle, said switch operatively connected to said air compressor so as to selectively deliver pressurized air to said apparatus to operate said coupling means to operatively disengage said rear driveline assembly from said transfer case output shaft so as to transfer rotational torque from said transfer case only to said front driveline assembly.
